(19) United States
(12) Patent Application Publication
(10) Pub. No.: US 2023/0137606 A1
(43) Pub. Date: May 4, 2023

(54) METHOD FOR POSITIONING IN A MAP AND SELF-PROPELLED DEVICE

(71) Applicant: ALL RING TECH CO., LTD., KAOHSIUNG CITY (TW)

(72) Inventor: Chung-Yuan LIU, KAOHSIUNG CITY (TW)

(21) Appl. No.: 18/051,021

(22) Filed: Oct. 31, 2022

(30) Foreign Application Priority Data
Nov. 1, 2021 (TW) 110140542

(51) Int. Cl. G05D 1/02; G06T 11/00

(52) U.S. Cl. CPC G05D 1/0274; G06T 11/00

(57) ABSTRACT

The present invention provides a method for positioning in a map and a self-propelled device. The method includes: providing the self-propelled device with a sensor, an embedded computer and a display; controlling the self-propelled device to move to a positioning point of a workspace; scanning, by the sensor, a physical structure in the workspace to obtain a structural feature when the self-propelled device is at the positioning point; performing a matching algorithm on the structural feature by the embedded computer to determine whether the structural feature matches the map structure around a mark in a map; and showing, by the display, a matching image for indicating a position of the self-propelled device in the map in response to determining that the structural feature matches the map structure; thereby decreasing occurrences for the wrong positioning of the self-propelled device in the map.

### RELATED APPLICATIONS

This application claims priority to Taiwan Application Serial Number 110140542, filed Nov. 1, 2021, which is herein incorporated by reference.

### BACKGROUND

### Technical field

The invention generally relates to a method for positioning in a map and a self-propelled device, and more particularly, relates to a method for positioning in a map and a self-propelled device adapted for determining a position and a direction of the self-propelled device in the map.

### Description of Related Art

Simultaneous localization and mapping (SLAM) technology has been widely used in traditional self-propelled devices. The self-propelled device may firstly travel in a workspace, and thus a structural feature of the workspace can be obtained by a sensor at the front side of the self-propelled device scanning a physical structure of the workspace. Then, the structural features are combined into a map having a map structure by a graph-building algorithm. Finally, the self-propelled device plans a moving path to perform work such as cleaning, inspection, transportation, etc., in accordance with the map information.

When the self-propelled device plans the moving path, it is needed to determine the position and the direction of the self-propelled device in the map at first, and the moving path can be planned by using the map. Generally, in a traditional method for positioning in the map, a positioning point is set at a predetermined position in the workspace and a mark point according to the positioning point is set in the map. Thereafter, an operator controls the self-propelled device to move to the position of the positioning point and adjusts the front side of the self-propelled device to face to a predetermined direction in a way of manually pushing or remote-control, thereby enabling the sensor disposed at the front side of the self-propelled device to obtain the structural features corresponding to the position of the self-propelled device being and the direction of the self-propelled device. Thereafter, the self-propelled device performs a matching operation on the structural feature obtained from the positioning point and the corresponding map structure around the mark point by using a matching algorithm. If the proportion of similar parts of the structural feature and the corresponding map structure is bigger than a predetermined value, the self-propelled device determines that the positioning is successful; if the proportion of similar parts of the structural feature and the corresponding map structure is lower than the predetermined value, the self-propelled device determines that the positioning is fail and needed to be performed again.

The method for positioning in the map mentioned above is shown as FIGS. 12 and 13. FIG. 12 illustrates a workspace Y with a physical structure Y1 to provide a self-propelled device X for moving. An arrow pattern indicates a forward direction of the self-propelled device X. A fan pattern indicates a scanning direction and a scanning range of a sensor. After scanning the workspace Y, the sensor obtains a structural feature Y2 of the workspace Y (the part indicated by dot patterns), and a positioning point Y3 is set at a predetermined position in the workspace Y. FIG. 13 illustrates a map Z with a map structure Z1 (the part indicated by line patterns) which is built after the self-propelled device scans the workspace Y. The white pattern of the map Z indicates a movable area that the self-propelled device X may move in, and no physical structure Y1 is scanned in the movable area. The slash pattern of the map Z indicates an immovable area that the self-propelled device X may not move in, and the physical structure Y1 is scanned in the immovable area. A mark point Z2 is set according to the positioning point Y3 in the map. Please referring to FIGS. 14 and 15, when the self-propelled device X needs positioning itself to obtain a position and a direction in the map Z, the self-propelled device X is moved to the positioning point Y3 and a scanning direction of the self-propelled device X is approximately adjusted to be toward the part of the physical structure Y1 adjacent to the positioning point Y3. After the self-propelled device X obtains the structural feature Y2 corresponding to the direction and the position, the self-propelled device X performs the matching operation on the structural feature Y2 obtained from the positioning point Y3 of the self-propelled device X and the corresponding map structure Z1 around the mark point Z2 by using the matching algorithm. Because the structural feature Y2 and the map structure Z1 are almost similar to each other in FIG. 14, the self-propelled device X therefore determines that the positioning is successful.

However, in the method for positioning in the map mentioned above, a following shortcoming easily occurs. As shown in FIGS. 16 and 17, if the self-propelled device X is moved to a wrong point Y4 and the scanning direction of the self-propelled device X is approximately adjusted to be toward the part of the physical structure Y1 adjacent to the wrong point Y4, the self-propelled device X performs a matching operation on a structural feature Y5 (the part indicated by dot patterns) obtained from the wrong point Y4 and the corresponding map structure Z1 (the line patterns) around the mark point Z2 by using the matching algorithm after the self-propelled device X obtains the structural feature Y5 corresponding to the position and the direction. Unexpectedly, though the self-propelled device X is at a different position and faces a different direction from the positioning point Y3, the structural feature Y5 and the map structure Z1 are just few differences in FIG. 17. In other words, the proportion of similar parts of the structural feature Y5 and the map structure Z1 is still bigger than the predetermined value, the self-propelled device X determines that the positioning is therefore successful. The aforementioned shortcoming results in wrong movements of the self-propelled device X under a wrong positioning condition. As shown in FIG. 18, the self-propelled device X is actually at the wrong point Y4 in the workspace Y but positions itself at the mark point Z2 in the map Z. When the self-propelled device X plans the moving path, the movable area in the map Z is actually over the workspace Y, and the immovable area in the map Z is actually appearing in the workspace Y, thereby increasing a trigger frequency of an anti-collision mechanism of the self-propelled device X. It can be seen that the aforementioned method for positioning in the map still has processes for improvement.

### SUMMARY

Therefore, a purpose of the invention is to provide a method for positioning in a map for decreasing the wrong positioning.

Another purpose of the invention is to provide a self-propelled device configured to perform the method for positioning in the map.

The method for positioning in the map in accordance with the purpose of the invention includes: providing a self-propelled device with a sensor, an embedded computer and a display; controlling the self-propelled device to move in a workspace; scanning, by the sensor, a physical structure in the workspace to obtain a structural feature; performing a graph-building algorithm on the structural feature by the embedded computer to build a map corresponding to the workspace, the map having a map structure and a mark, the map structure corresponding to the physical structure, and the mark indicating a position of the self-propelled device in the map; and displaying, by the display, the map and showing the structural feature in the map.

The method for positioning in the map in accordance with the purpose of the invention includes: providing a self-propelled device with a sensor, an embedded computer and a display; controlling the self-propelled device to move to a positioning point of a workspace; scanning, by the sensor, a physical structure in the workspace to obtain a structural feature when the self-propelled device is at the positioning point; performing a matching algorithm on the structural feature by the embedded computer to determine whether the structural feature matches a map structure around a mark in a map; and showing, by the display, a matching image for indicating a position of the self-propelled device in the map in response to determining that the structural feature matches the map structure.

The self-propelled device in accordance with another purpose of the invention is adapted for performing the method for positioning in the map.

According to some embodiments of the invention of the method for positioning in the map and the self-propelled device, when the self-propelled device is at the positioning point in the workspace, the display shows the structural feature via scanning the physical structure by the sensor and the map structure of the map, which provides an operator to read and determine whether the structural feature matches the map structure, thereby decreasing occurrences for the wrong positioning of the self-propelled device in the map.

### BRIEF DESCRIPTION OF THE DRAWINGS

FIG. 1 is a schematic diagram of a self-propelled device in accordance with some embodiments of the invention.

FIG. 2 is a schematic diagram of a self-propelled device in a workspace in accordance with some embodiments of the invention.

FIG. 3 is a schematic diagram of a map according to a workspace in accordance with some embodiments of the invention.

FIG. 4 is a schematic diagram of scanning a workspace at a positioning point in the workspace by a self-propelled device in accordance with some embodiments of the invention.

FIG. 5 is a schematic diagram of a first option displayed by a display in accordance with some embodiments of the invention.

FIG. 6 is a schematic diagram of a second option and a third option displayed by a display in accordance with some embodiments of the invention.

FIG. 7 is a schematic diagram of a structural feature scanned at a positioning point by a self-propelled device matching a map structure in accordance with some embodiments of the invention.

FIG. 8 is a schematic diagram of a whole of a map displayed and a structural feature matching a map structure thereof shown by a display in accordance with some embodiments of the invention.

FIG. 9 is a schematic diagram of a part of a map zoomed in and a structural feature matching a map structure thereof shown by a display in accordance with some embodiments of the invention.

FIG. 10 is a schematic diagram of a mark indicating a direction to which a front side of a self-propelled device faces in accordance with some embodiments of the invention.

FIG. 11 is a flowchart of a method for positioning in a map in accordance with some embodiments of the invention.

FIG. 12 is a schematic diagram of a self-propelled device in a workspace in accordance with a prior art.

FIG. 13 is a schematic diagram of a map according to the workspace in accordance with the prior art.

FIG. 14 is a schematic diagram of scanning the workspace at a positioning point in the workspace by the self-propelled device in accordance with the prior art.

FIG. 15 is a schematic diagram of a structural feature scanned at the positioning point by the self-propelled device matching a map structure in accordance with the prior art.

FIG. 16 is a schematic diagram of scanning the workspace at a wrong point in the workspace by the self-propelled device in accordance with the prior art.

FIG. 17 is a schematic diagram of the structural feature scanned at the wrong point by the self-propelled device matching the map structure in accordance with the prior art.

FIG. 18 is a schematic diagram of the self-propelled device with a wrong positioning in the map in accordance with the prior art.

### DETAILED DESCRIPTION

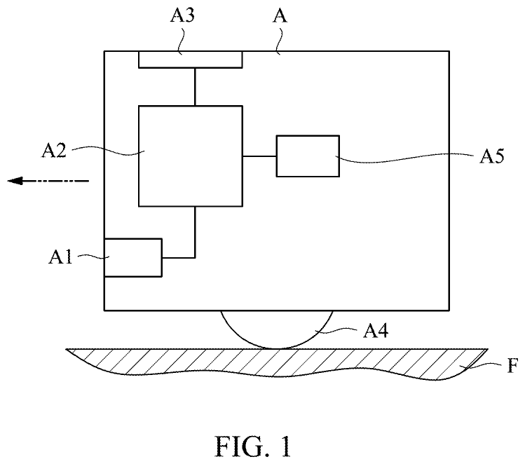

Please referring to FIG. 1, a method for positioning in a map in embodiments of the present invention may be performed by a self-propelled device A as shown in FIG. 1. The self-propelled device A is configured with a sensor A1, an embedded computer A2, a display A3, a drive unit A4 and a controller A5. The sensor A1 may be a sensor, such as a light detection and ranging (LIDAR). The sensor A1 is disposed at a front side of the self-propelled device A and has a predetermined scanning direction and a predetermined range. The embedded computer A2 may compute and save data by using multiple algorithms. The display A3 may be a display, such as a touch screen. The display A3 is disposed at an upper side of the self-propelled device A and is convenient for an operator to confirm and operate. The drive unit A4 is disposed at a lower side of the self-propelled device A and may drive the self-propelled device A to perform some actions on a working surface, such as going forward, going backward, rotating, etc. The controller A5 may perform various control functions. For example, the controller A5 controls an action of the drive unit A4.

Please referring to FIGS. 1, 2 and 3, the self-propelled device A may move in a workspace W to build a map T of the workspace W. There are physical structures W1 in the workspace W, such as walls or obstacles, etc. A forward direction in the workspace of the self-propelled device A is indicated by an arrow pattern A, and the scanning direction and the range of the sensor A1 in the workspace W is indicated by a fan pattern.

When the self-propelled device A moves in the workspace W, the sensor A1 may scan the physical structure W1 located in front of the self-propelled device A in the workspace W to obtain a structural feature W2 (the part indicated by dot patterns). The sensor A1 may transmit the data to the embedded computer A2 for computing, thereby combining all the structural features W2 into the map T by using a graph-building algorithm by the embedded computer A2 after the self-propelled device A travels the workspace Y, and the map T is saved in the embedded computer A2. The map T has a map structure T1 (the part indicated by line patterns), and that is the map structure T1 corresponding to the physical structures W1 in workspace W, such as aforementioned walls and/or obstacles. In some embodiments, the graph-building algorithm can be, for example, a graph-based simultaneous localization and mapping algorithm, thereby using the information (that is the appearances of physical structures and the corresponding positions) received by the sensor A1 to build the map. The map includes the structural features corresponding to the physical structures and the corresponding position information. For example, the sensor A1 may be used to scan the walls and/or the obstacles of the workspace W to obtain the corresponding information of appearances and positions, and the map is illustrated for building according to the information collected from the sensor A1 by the embedded computer A2.

Because the self-propelled device A may perform works, such as cleaning, cruising and rummaging, transporting on different floors or at different site therein, plural workspaces are assigned for the self-propelled accordingly. The self-propelled device A may firstly go to different workspaces to build different maps T and save the maps T in the embedded computer A2. When the self-propelled device A comes to the workspace W where the self-propelled device A need to work, the self-propelled device A again positions its position and its direction in the map T to plan a work's moving path by the map T.

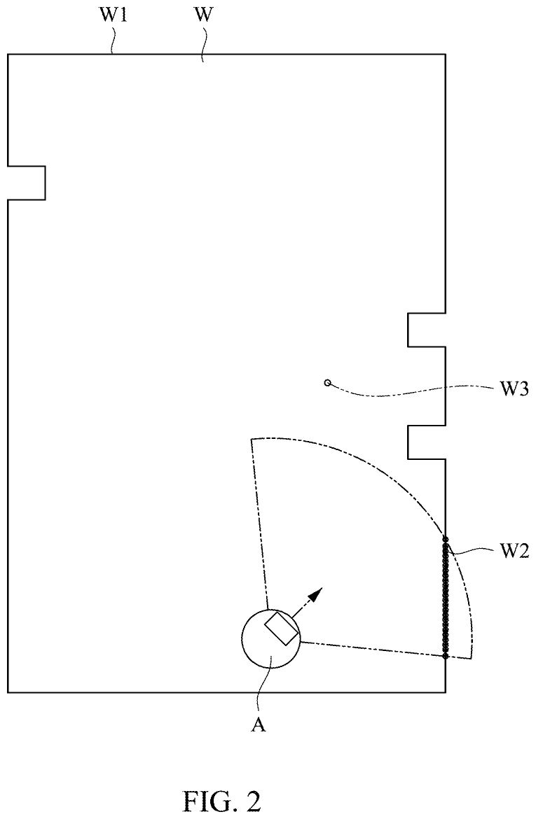

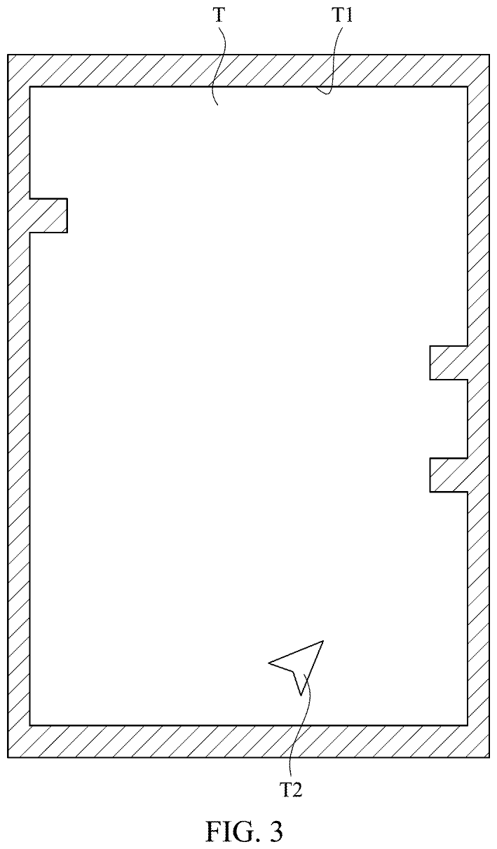

Please referring to FIGS. 2 and 3, a positioning point W3 is set at a predetermined position in the workspace W. The positioning point W3 is set at a periphery of the part with identifying features of the physical structure according to an operator's experience, such as concave walls and/or convex walls. Plural positioning points W3 can be set. The map T has a mark T2 indicating the position of the self-propelled device A according to the map T. The mark T2 indicates the scanning direction of the sensor A1 (FIG. 1) by an indicative pattern (arrow). In the map T, a white pattern is a movable area that no physical structure W1 is scanned in the movable area, and a slash pattern is an immovable area that the physical structure W1 is scanned in the immovable area.

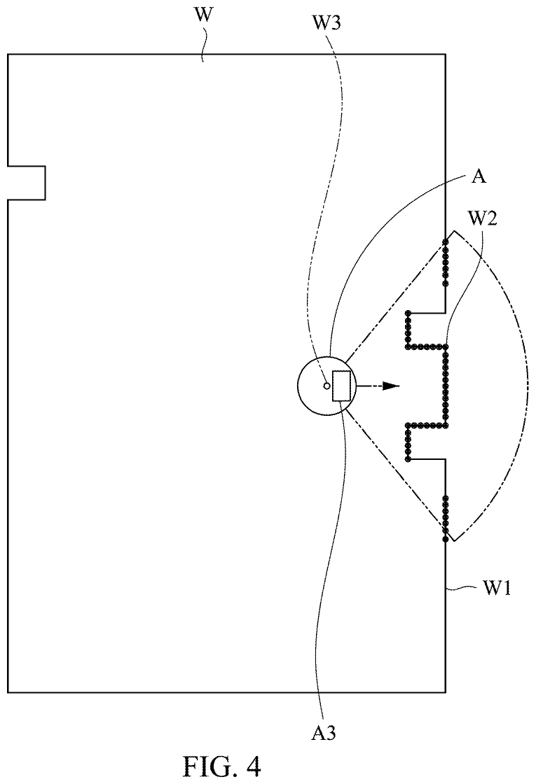

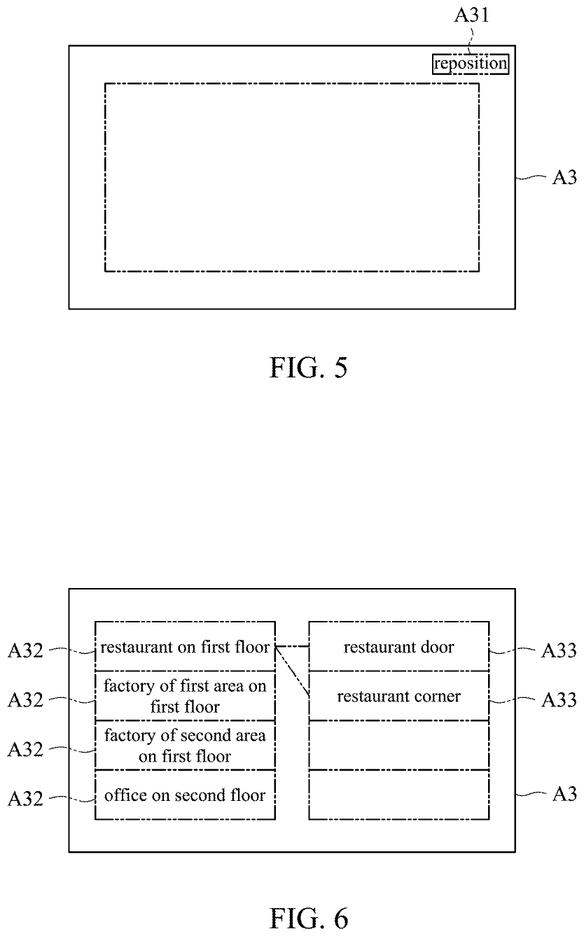

The method for positioning in the map in some embodiments of the invention is performed. Please referring to FIGS. 4 and 5, the operator controls the self-propelled device A to move to the position of the positioning point W3 at first through a method of manually pushing or remote control and adjusts the front side of the self-propelled device A to face to a predetermined direction (the self-propelled device A is approximately facing the part of the physical structure

W1 adjacent to the positioning point W3 here). After the self-propelled device A moves to the positioning point W3, the operator operates to select a first option A31 (such as displayed ‘reposition’ in the upper right-hand corner of the display) and the self-propelled device A may start to position.

Please referring to FIGS. 4, 5 and 6, after the operator selects the first option A31, the display A3 switches to display plural second options A32 and plural third options A33 to provide for the operator to read, determine and operate. The second options A32 represent the maps T according to the workspaces W (such as ‘restaurant on first floor’, ‘factory of first area on first floor’, ‘factory of second area on first floor’, ‘office on second floor’), and the third options A33 represent the predetermined positions of the positioning points W3 in each workspace W (such as ‘restaurant door’, ‘restaurant corner’), in which the third options A33 may be again displayed after the operator selects the corresponding second option A32 of the workspace W.

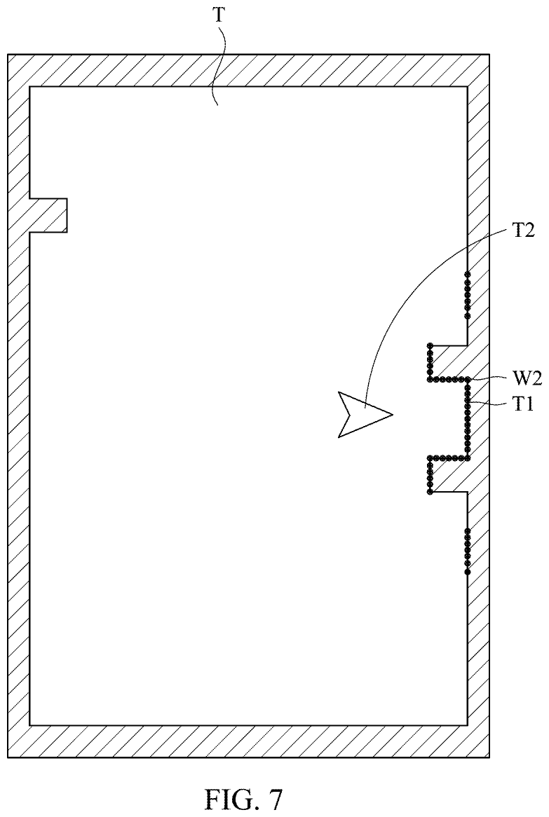

Please referring to FIGS. 4 and 7, after the operator selects the map T of the corresponding workspace W and the positioning point W3, the sensor Al performs scanning to obtain the structural feature W2 corresponding to the position and the direction of the positioning point W3. The embedded computer A2 performs a matching operation on the structural feature W2 obtained from the positioning point W3 at which the self-propelled device A works and the corresponding map structure T1 around the mark T2 by using a matching algorithm. If the proportion of similar parts of the structural feature W2 and the corresponding map structure T1 is bigger than a predetermined value, the embedded computer A2 of the self-propelled device A determines that the positioning is successful; if the proportion of similar parts of the structural feature W2 and the corresponding map structure T1 is lower than the predetermined value, the embedded computer A2 of the self-propelled device A determines that the positioning is fail and needed to be performed again. The matching algorithm is a technology that the embedded computer A2 executes to perform the comparing operation based on the structural feature W2 (that is the appearances of physical structures) actually and presently obtained from the sensor A3 at the positioning point W3 and the corresponding map structure T1 around the mark T2 (it means the corresponding position of the self-propelled device A in the map T) of the map T built and stored in advance, thereby finding out similar objects through the corresponding relationship between two structures, features, etc.

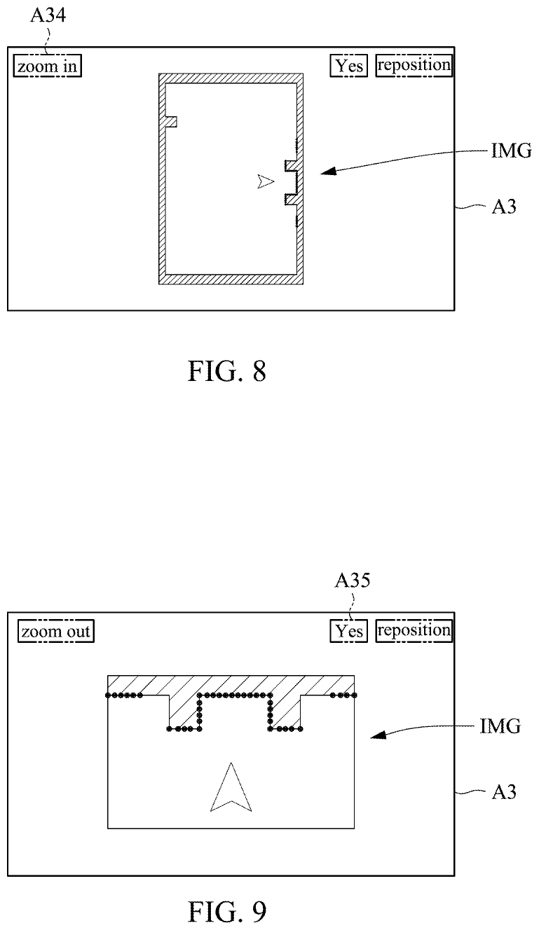

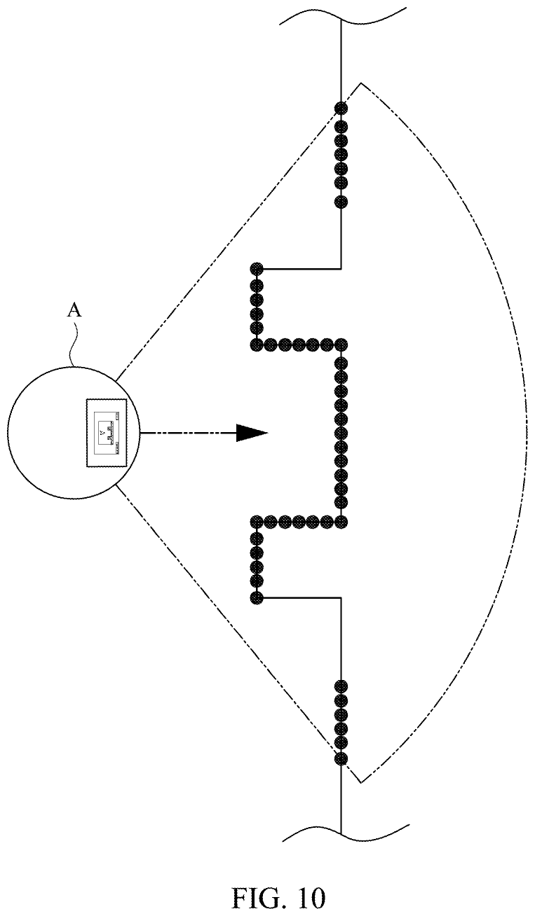

Please referring to FIGS. 4, 7, 8 and 9, after the structural feature W2 successfully matches the map structure T1, the display A3 displays the map T and shows the structural feature W2 in the map T obtained from the physical structure W1 that the sensor A1 (FIG. 1) presently scans under a condition that the self-propelled device A stops moving at the positioning point W3, and thus the display A3 shows a matching image IMG of the structural feature W2 and the map structure T1, in which the display A3 firstly displays a whole of the map T (as shown in FIG. 8), the operator may control the display A3 to zoom in to display a part of the map T (as shown in FIG. 9) by selecting a fourth option A34 (such as ‘zoom in’) beside the image IMG. And no matter where the whole of the map T originally position on the display A3 is, the display A3 shows a predetermined range of the map T around the mark T2, and the mark T2 indicates a direction to which the front side of the self-propelled device A faces (as shown in FIGS. 9 and 10), when the display A3 zooms in to display the part of the map T.

When the display A3 shows the image IMG, the operator may confirm the position of the self-propelled device A in the map T based on the image IMG shown by the display A3. If the operator reads and determines that the structural feature W2 also matches the map structure T1, the operator operates to select a fifth option A35 (such as ‘yes’) beside the image IMG and to complete the positioning; if the operator reads and determines that the structural feature W2 doesn't match the map structure T1, the operator operates to select the first option A31 (such as displayed ‘reposition’ in the upper right-hand corner of the display) and the self-propelled device A starts to position again.

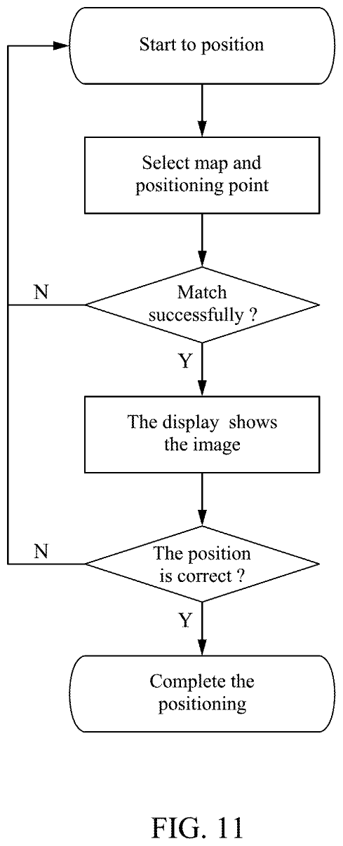

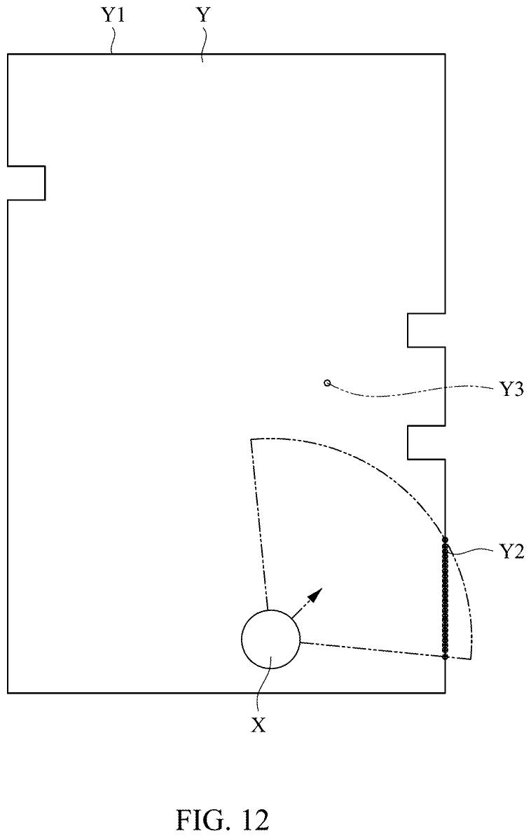

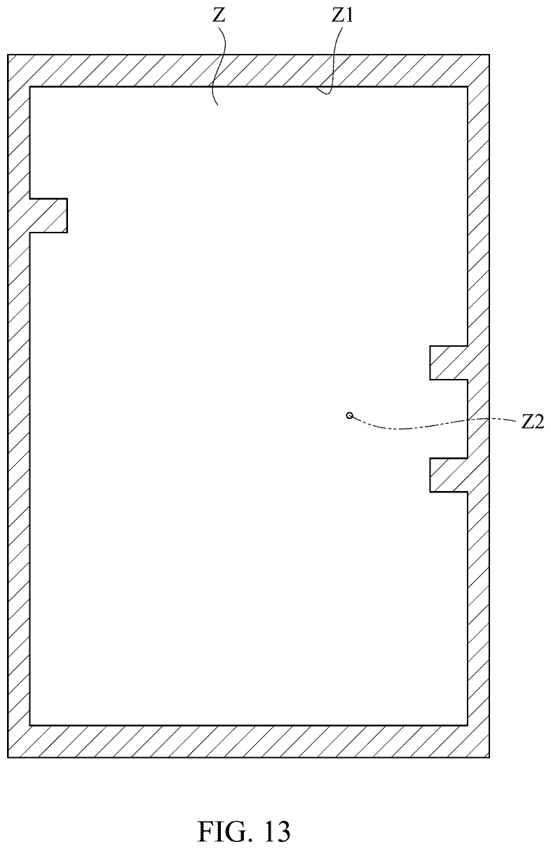

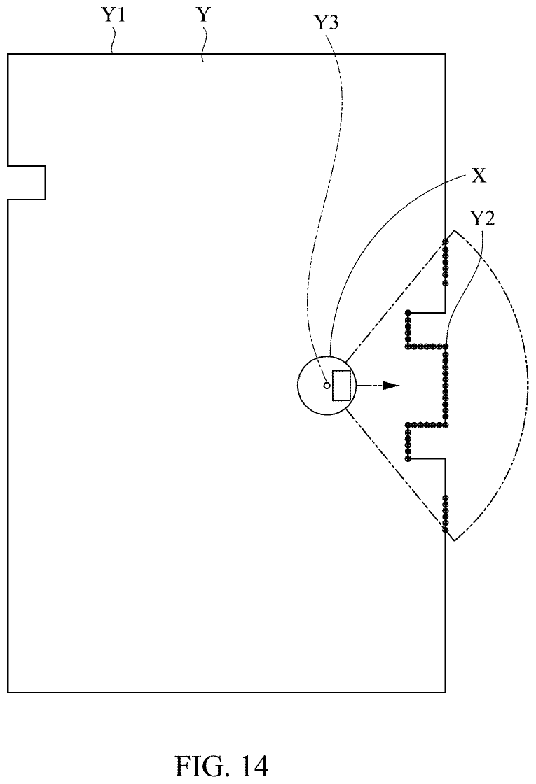

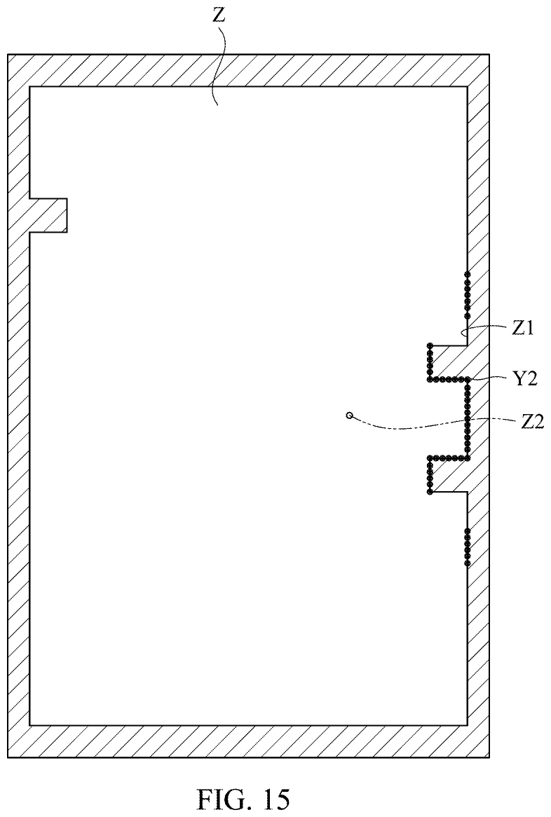

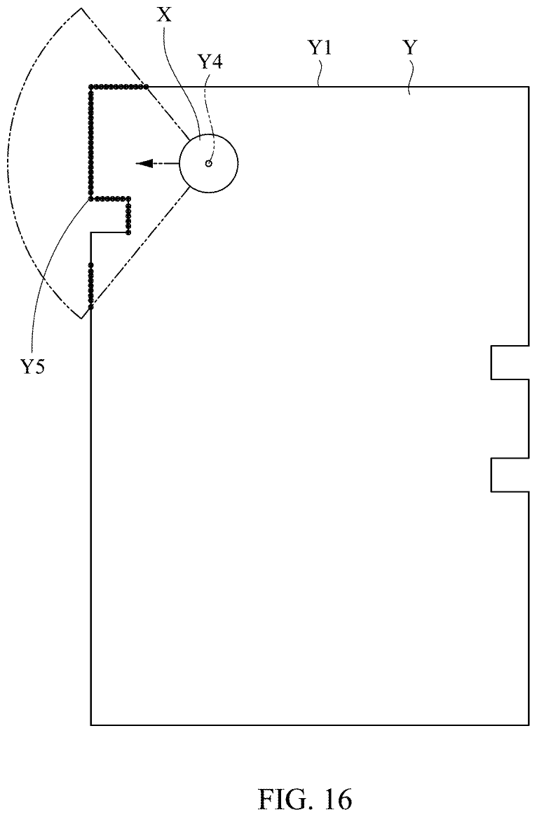

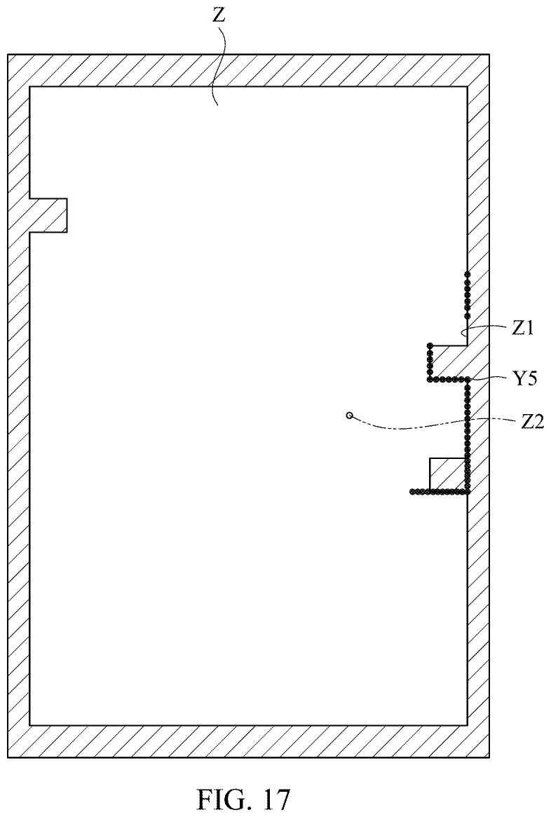

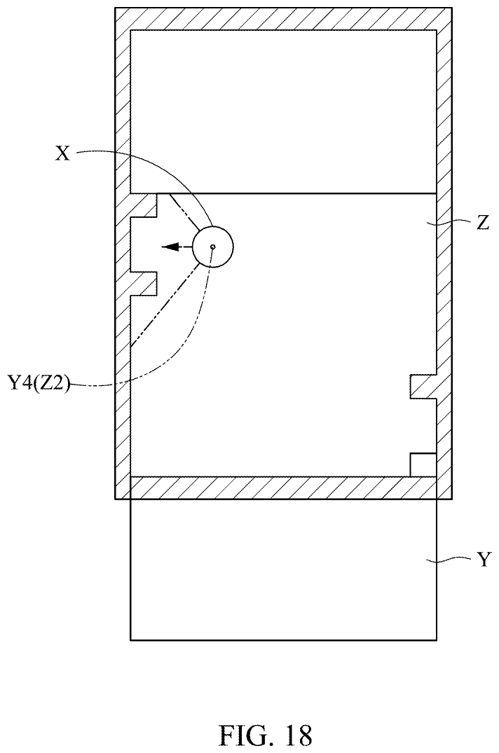

The processes of the mentioned method for positioning in the map may be shown in FIG. 11.

In some embodiments of the invention of the method for positioning in the map and the self-propelled device, when the self-propelled device A is at the positioning point W3 in the workspace W, the display A3 shows the structural feature W2 obtained from the physical structure W1 that the sensor A1 scans and the map structure T1 to provide the operator for reading and determining whether the structural feature W2 matches the map structure T1, thereby decreasing occurrences for the wrong positioning of the self-propelled device A in the map T.

Although the invention is described above by means of the implementation manners, the above description is not intended to limit the invention. A person of ordinary skill in the art can make various variations and modifications without departing from the spirit and scope of the invention, and therefore, the protection scope of the invention is as defined in the appended claims.

What is claimed is:

1. A method for positioning in a map, comprising:
providing a self-propelled device with a sensor, an embedded computer and a display;
controlling the self-propelled device to move in a workspace;
scanning, by the sensor, a physical structure in the workspace to obtain a structural feature;
performing a graph-building algorithm on the structural feature by the embedded computer to build a map corresponding to the workspace, the map having a map structure and a mark, the map structure corresponding to the physical structure, and the mark indicating a position of the self-propelled device in the map; and
displaying, by the display, the map and showing the structural feature in the map.

2. The method of claim 1, wherein the self-propelled device stops moving at a positioning point in the workspace when the map is displayed and the structural feature is shown by the display.

3. The method of claim 2, wherein the physical structure is a wall or an obstacle in the workspace, and the positioning point is disposed correspondingly at a periphery of the physical structure.

4. The method of claim 1, wherein the display is configured to display a whole of the map or a part of the map, and the display is configured to show a predetermined range of the map around the mark when the display displays the part of the map.

5. The method of claim 1, wherein the sensor is disposed at a front side of the self-propelled device, and the mark is an indicative pattern for indicating a scanning direction of the sensor.

6. The method of claim 5, wherein the display is disposed at an upper side of the self-propelled device, and the indicative pattern indicates a direction to which the front side of the self-propelled device faces.

7. A self-propelled device configured to perform the method of claim 1.

8. A self-propelled device configured to perform the method of claim 2.

9. A self-propelled device configured to perform the method of claim 3.

10. A self-propelled device configured to perform the method of claim 4.

11. A self-propelled device configured to perform the method of claim 5.

12. A self-propelled device configured to perform the method of claim 6.

13. A method for positioning in a map, comprising:
providing a self-propelled device with a sensor, an embedded computer and a display;
controlling the self-propelled device to move to a positioning point of a workspace;
scanning, by the sensor, a physical structure in the workspace to obtain a structural feature when the self-propelled device is at the positioning point;
performing a matching algorithm on the structural feature by the embedded computer to determine whether the structural feature matches a map structure around a mark in a map; and
showing, by the display, a matching image for indicating a position of the self-propelled device in the map in response to determining that the structural feature matches the map structure.

14. The method of claim 13, wherein the sensor is disposed at a front side of the self-propelled device, and the mark is an indicative pattern for indicating a scanning direction of the sensor.

15. The method of claim 14, wherein the display is disposed at an upper side of the self-propelled device, the display is configured to display a whole of the map or a part of the map, and the display shows a predetermined range of the map around the mark, and the indicative pattern indicates a direction to which the front side of the self-propelled device faces when the display displays the part of the map.

16. The method of claim 13, wherein the physical structure is a wall or an obstacle in the workspace, and the positioning point is disposed correspondingly at a periphery of the physical structure.

17. A self-propelled device configured to perform the method of claim 13.

18. A self-propelled device configured to perform the method of claim 14.

19. A self-propelled device configured to perform the method of claim 15.

20. A self-propelled device configured to perform the method of claim 16.
